(19) United States
(12) Patent Application Publication
(10) Pub. No.: US 2005/0161625 A1
(43) Pub. Date: Jul. 28, 2005

(54) Adjustable metering actuator assembly for a water closet

(76) Inventors: Thomas P. Beh, Chicago, IL (US); Shannon R. Bantz, Michigan City, IN (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 11/081,382

(22) Filed: Mar. 16, 2005

Related U.S. Application Data
(63) Continuation-in-part of application No. 10/445,525, filed on May 27, 2003, now Pat. No. 6,896,237.
Application No. 10/445,525 is a continuation-in-part of application No. 09/827,736, filed on Apr. 6, 2001, now Pat. No. 6,732,997.
(60) Provisional application No. 60/195,094, filed on Apr. 6, 2000.

(51) Int. Cl. F16K 47/00; F16L 55/02; E03D 1/14; E03D 3/12

(52) U.S. Cl. 251/122

(57) ABSTRACT

An adjustable metering actuator assembly for controlling the operation of a flush valve of a pressurized water closet includes a plunger assembly including a plunger carrying a tapered needle valve pin that is axially movable relative to an inlet orifice, the closing speed of the flush valve controlled by the fluid flow rate through the inlet orifice and the needle valve pin axially repositionable with respect to the plunger to change the diametral clearance between the tapered portion of the needle valve pin and the inlet orifice, thereby adjusting the fluid flow rate through the inlet orifice and thus, the bowl refill volume of the pressurized water closet.

### CROSS REFERENCE TO RELATED APPLICATIONS

This application is a continuation-in-part of application Ser. No. 10/445,525, which was filed on May 27, 2003, which is a continuation-in-part of application Ser. No. 09/827,736, which was filed on Apr. 6, 2001, now U.S. Pat. No. 6,732,997, both of which claim priority from Provisional Application No. 60/195,094, which was filed on Apr. 6, 2000.

### BACKGROUND OF THE INVENTION

Field of the Invention

The present invention relates generally to flush valves for pressurized water closets, and more particularly, to an adjustable metering actuator assembly for such flush valves.

The basic components of a pressurized water closet are a water vessel, a flush valve and a flush valve actuator. The aforesaid components are generally installed internally of a conventional water closet. The pressurized water closet is energized by water pressure from a conventional fresh water supply system.

In operation, as the water level rises in the water vessel after flush, air internally of the water vessel is compressed. When water pressure in the vessel equals the supply line pressure, or when it causes a pressure regulator valve to shut in the event of supply line pressure greater than that allowed by the regulator, flow of water into the water vessel ceases and the system is conditioned for operation. When the flush valve actuator is actuated, the flush valve opens whereafter the compressed air in the water vessel pushes the water stored therein into the water closet bowl at relatively high discharge pressure and velocity, flushing waste therefrom with minimum water consumption.

The aforesaid features of the pressurized flush system result in stronger and more effective extraction and drain line carry, cleaner bowls, fewer drain line clogs, no hidden leakage of water between flushes, and smaller sized pipe systems. The system produces a flushing action which clears and cleans a toilet bowl while consuming less than one and six tenths gallons of water while meeting the highest municipal codes. The toilet bowl is emptied by one flush without drain line “drop-off” common to many low water volume or gravity-flow type toilets.

More specifically, in operation, actuation of the manual operator creates a pressure differential across a flush valve piston disposed in a flush valve cylinder. The flush valve piston and a flush valve therefore move upwardly at a controlled rate.

Upward or opening movement of the flush valve permits water to be ejected into the toilet bowl from the water vessel under relatively high pressure effecting extraction of the contents of the toilet bowl. Flush commences simultaneously with manual depression of the flush valve actuator and is time controlled so as to produce a prolonged high energy surge of water which carries bowl waste into the sewer.

Closure of the flush valve is timed by the distribution ratio of incoming water to the upper chamber of the flush valve cylinder and the water vessel. When the manual flush valve actuator is released, the fluid flow path from the upper chamber of the flush valve cylinder to ambient is closed. At this point, a predetermined portion of the water supplied under pressure from the water supply system flows directly to the upper chamber of the flush valve cylinder. The remaining portion of water supplied by the system flows to the main chamber of the water vessel. When the upper chamber of the flush valve cylinder is filled, and the flush valve is closed, all incoming water is directed into the water vessel. Water rising in the water vessel under regulated water system pressure compresses the air entrapped therein until it reaches either the line or regulated pressure of approximately 30 psi, whichever occurs first. At this point, flow stops and the system is ready to be flushed again.

Control valves currently available for pressurized water closet flushing systems do not permit the ready and simple adjustment of the predetermined portion of the water supplied under pressure while maintaining a flush action independent of actuator depression and a self cleaning action.

Most known flush valve actuators use a fixed actuator that does not allow adjustment in the distribution ratio of incoming water to the upper chamber of the flush valve cylinder and the water vessel and thus the bowl refill volume of the pressurized water closet.

In one known fluid metering actuator, separate needles are used to provide different flow rates. Changing the flow rate for this unit requires disassembly of the fluid metering actuator to allow changing of the size of the needle valve pin.

It is accordingly the primary objective of the present invention that it provide an improved metering actuator assembly for flush valves.

Another objective of the present invention is that it provide a metering actuator assembly for flush valves that allows adjustment without disassembly of the flush valve.

A further objective of the present invention is that it provide a metering actuator assembly for flush valves that is adjustable.

Another objective of the present invention is that it provide a metering actuator assembly for a flush valve that substantially eliminates the leak path interface between the valve seat and seal when the metering actuator assembly is in the closed condition.

The apparatus of the present invention must also be of construction which is both durable and long lasting, and it should also require little or no maintenance to be provided by the user throughout its operating lifetime. In order to enhance the market appeal of the apparatus of the present invention, it should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. With this invention, there is provided a fluid metering actuator assembly for pressurized water closet flushing systems. The fluid metering actuator assembly includes a housing defining an inlet orifice, an actuator valve within the housing for operating the flush valve and a plunger slidably supported within the housing for operating the actuator valve. A needle valve pin is supported within the housing for axial movement relative to the plunger. The needle valve pin is aligned with the inlet orifice, an axial position of the needle valve pin defining a fluid flow rate through the inlet orifice. At least a portion of the needle valve pin that is located adjacent the inlet orifice has a varying in diameter. The needle valve pin cooperates with the inlet orifice to define a bowl refill volume of the pressurized water closet.

The closing speed of the flush valve is controlled by the fluid flow rate through the inlet orifice and the needle valve pin is axially repositionable with respect to the plunger to thereby adjust the fluid flow rate through the inlet orifice and thus the bowl refill volume of the pressurized water closet. Axially repositioning the needle valve pin changes the diametral clearance between the portion of the needle valve pin and the inlet orifice, thereby adjusting the fluid flow rate through the inlet orifice.

An adjustment member, accessible from the exterior of the housing, is operable to cause axial repositioning of the needle valve pin with respect to the plunger and the inlet orifice. A push rod, interposed between the adjustment member and the needle valve member, couples the needle valve member to the adjustment member allowing the needle valve pin to be moved axially with respect to the plunger, such as by rotating the adjustment member.

The needle valve pin is supported within the housing to be repositionable along a longitudinal axis of the plunger. In accordance with an embellishment, the needle valve pin is supported within the housing to be repositionable along an axis that extends normal to a longitudinal axis of the plunger.

In accordance with another aspect of the invention, the adjustable fluid metering actuator assembly includes a seal member carried by a first valve component of the actuator valve. The seal member has a surface that presents an acute angle with respect to a mating surface of a second valve component of the actuator, thereby reducing axial shift for the assembly of the plunger, the pushrod and the needle valve pin due to compression of the seal member when the actuator valve is in the closed condition. Moreover, the seal member prevents back flow of liquid through mating threads on the plunger and the first valve component when the actuator valve is in a closed condition.

It may therefore be seen that the present invention teaches a fluid metering actuator assembly that includes an actuator valve within a housing for operating a flush valve and a plunger slidably supported within the housing for operating the actuator valve. A needle valve pin is supported within the housing for axial movement relative to an inlet orifice defined by the housing. The needle valve pin is aligned with the inlet orifice and a portion of the needle valve pin that is located adjacent the inlet orifice has a varying diameter so that the axial position of the needle valve pin defines the fluid flow rate through the inlet orifice. The needle valve pin cooperates with the inlet orifice to define a bowl refill volume of the pressurized water closet.

The apparatus of the present invention is of a construction which is both durable and long lasting, and one that will require that little or no maintenance be provided by the user throughout its operating lifetime. The apparatus of the present invention is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1, which is labeled “prior art”, is an elevational view of a water closet flushing system according to the prior art;

FIG. 2, which is labeled “prior art”, is a cross sectional view taken along the line 2-2 of FIG. 1;

FIG. 3 is a cross sectional view of a fluid metering actuator assembly of the instant invention, wherein the metering pin is maximally advanced;

FIG. 4 is a view similar to that of FIG. 3, wherein the metering pin is minimally advanced;

FIG. 5 is a fragmentary view, in section, showing a splined valve stem of an alternative metering actuator assembly according to the invention;

FIG. 6 is a transverse sectional view of a valve stem of a metering actuator assembly, wherein the needle valve pin is tapered;

FIG. 7 is a cross sectional view of a fully charged pressurized water closet flushing system including an adjustable fluid metering actuator assembly according to the present invention;

FIG. 8 is an isometric view in section, of the adjustable metering actuator assembly according to the invention;

FIG. 9 is a transverse sectional view, taken along the lines 9-9 of FIG. 7 and showing the needle valve pin of the adjustable metering actuator assembly maximally advanced;

FIG. 10 is an enlarged fragmentary view showing the interface between a seal and a valve seat for the metering actuator assembly of FIG. 8;

FIG. 11 is an enlarged fragmentary view taken along the line 11-11 of FIG. 9, showing the needle advanced;

FIG. 12 is a view similar to that of FIG. 9 wherein the needle valve pin is shown minimally advanced;

FIG. 13 is an enlarged fragmentary view taken along the line 13-13 of FIG. 12, showing the needle is minimally advanced;

FIG. 14 is an isometric transverse section view of an alternative adjustable metering actuator assembly including a needle jet valve;

FIG. 15 is an enlarged fragmentary view showing details of the needle jet valve of FIG. 14;

FIG. 16 is an isometric view of an alternative adjustable metering actuator assembly in accordance with the present invention;

FIG. 17 is an exploded view of the metering actuator assembly of FIG. 16;

FIG. 18 is a simplified view showing the needle valve pin of the metering actuator assembly of FIG. 16 minimally extended relative to the orifice;

FIG. 19 is a simplified view showing the needle valve pin of the metering actuator assembly of FIG. 16 maximally extended relative to the orifice;

FIG. 20 is a side elevation view of a cover of a needle valve pin holder of the metering actuator assembly of FIG. 16;

FIG. 21 is a bottom plan view of the cover shown in FIG. 20;

FIG. 22 is an end elevation view of the cover shown in FIG. 20;

FIG. 23 is a side elevation view of a base of a needle valve pin holder of the metering actuator assembly of FIG. 16;

FIG. 24 is a top plan view of the base shown in FIG. 23;

FIG. 25 is an end elevation view of the base shown in FIG. 23;

FIG. 26 is a view of an actuator stem of the metering actuator assembly of FIG. 16; and

FIGS. 27-29 are views showing successive steps in a flush operation.

### DETAILED DESCRIPTION OF THE PREFERRED EMBODIMENT

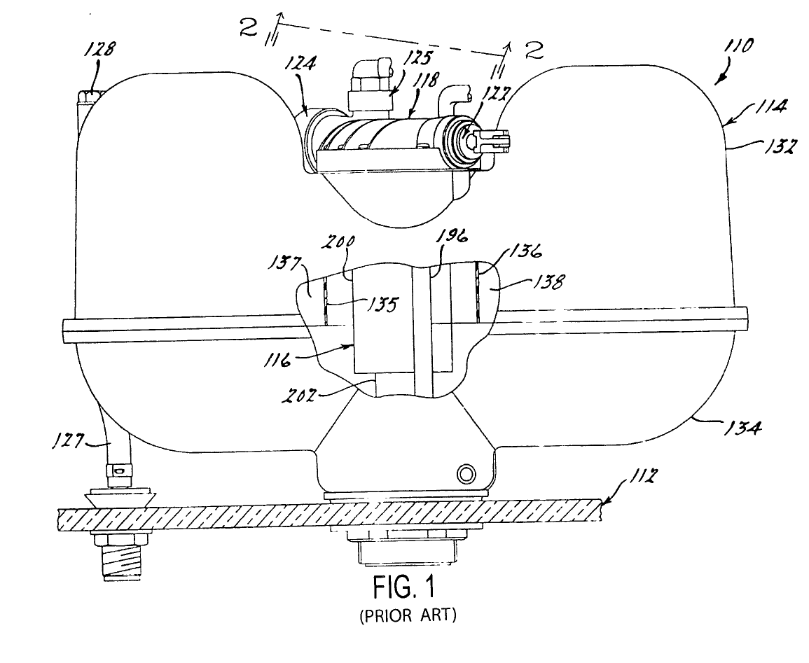

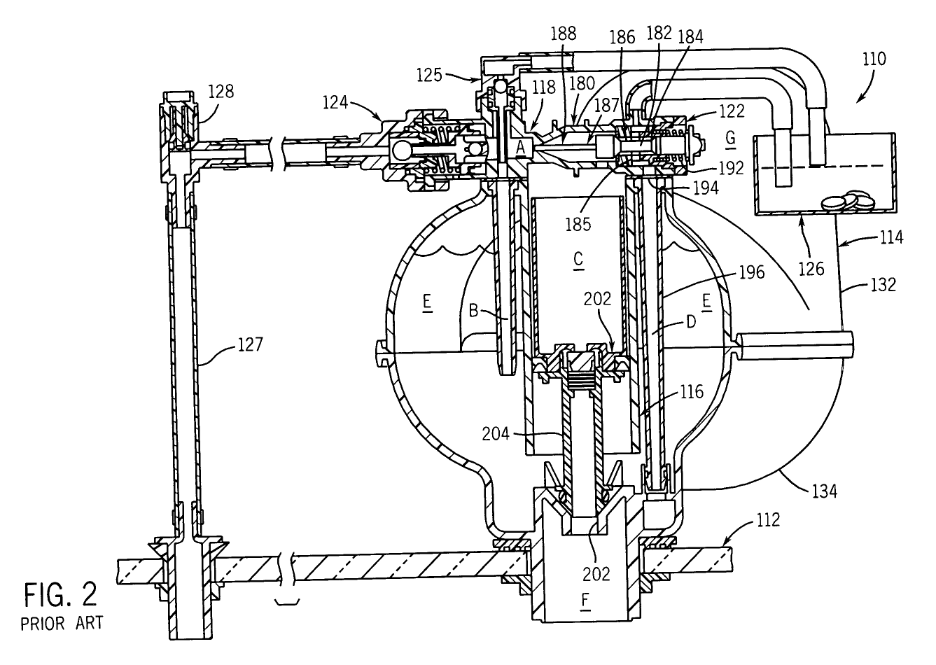

As seen in FIGS. 1 and 2, a pressurized water closet flushing system 110, in accordance with the prior art represented by U.S. Pat. No. 5,970,527 to Martin et al., is shown in operative association with a conventional water closet tank 112. Major components of the system 110 are a water vessel 114, an internal flush valve assembly 116, and a manifold 118 comprising an integral metering actuator assembly 122, a water pressure regulator 124, an air induction regulator 125, and a disinfectant reservoir 126 (FIG. 2).

Water is supplied to the system 110 from a pressurized source (not shown) and flows upwardly without restriction through an inlet conduit 127 and vacuum breaker 128, thence laterally to the manifold 118. Water is free to flow through the conduit 127 to the manifold 118 at system pressure thence, after regulation, to both the flush valve assembly 116 and water vessel 114, as will be described.

In the preferred constructed embodiment disclosed, the water vessel 114 comprises a pair of vertically stacked half sections 132 and 134. The upper section 132 of the water vessel 114 has a pair of downwardly extending partitions 135 and 136 that create isolated chambers 137 and 138, respectively as long as the water level is above the weld joint between the sections 132 and 134 of the water vessel 114, a typical condition between flushes. Accordingly, because the compressed air in the chambers 137 and 138 which powers the system 110 is isolated, a leak in an upper portion of the flush valve assembly 116 will not result in the system 110 becoming waterlogged.

The manifold 118, including the water pressure regulator 124, air induction regulator 125 and flush valve actuator 122, is mounted on the upper section 132 of the water vessel 114.

The manifold 118 also includes the metering actuator assembly 122 according to the existing art, which comprises a cylindrical housing 180 with a manually operable spool 182 disposed internally thereof that is slidably journaled in a sleeve 184. The spool 182 carries a valve member 185 that is normally seated on a valve seat 186. A needle valve 187 is supported on one end of the spool 182 so as to extend into an inlet orifice 188 in the housing 180 to define the area of an annular water inlet orifice that controls the flow of water to the flush valve assembly 116.

Movement of the spool 182 of the metering actuator assembly 122 against the bias of a spring 192 moves the valve member 185 off the valve seat 186 to open communication between an upper chamber “C” of the flush valve assembly 116, through an orifice 194 to a pressure relief tube 196 to initiate a flush. The tube 196 communicates with ambient pressure in the toilet bowl (not shown).

In operation, the water vessel 114 is fully charged with air and water and the system 110 is ready for flush. Zones (A), (B), (C) and (E) are pressurized. Zones (D), (F) and (G) are at atmospheric pressure. A flush occurs when the actuator spool 182 of the metering actuator assembly 122 is depressed, allowing pressurized water in zone “C” to discharge through the metering actuator assembly 122 into zone “D” thence to zone “F” as well as to flow through the water inlet conduit. The pressure differential established between zone “E” and zone “C” forces the piston 204 of the flush valve assembly 116 to lift, creating an escape path for water in zone “E” through the discharge aperture 202 into the toilet bowl at zone “F”. It is to be noted that the piston 204 of flush valve assembly 116 lifts, for example, 0.40 inches, discharging only a corresponding volume of water from zone “C”. This volume of water is determined to be the amount of water capable of being discharged through the metering actuator assembly 122 in ¼ second. As a result, the same amount of water is required after each flush to refill zone “C” and cause the flush valve assembly 116 to seal regardless of whether the spool 182 of the metering actuator assembly 122 is depressed for more than a fraction of a second, such as ¼ second, for example.

As flush progresses, pressure in zone “E” begins to lower, allowing the regulator 124 to begin opening and flow to begin through zone “A” to zones “B” and “C”. The flow through zones “A” and “B” is at maximum when pressure within zone “E” is zero.

It is to be noted that the size of the needle valve orifice 188 in conjunction with the needle valve 187 controls the flow rate of new water into the upper chamber “C” of the flush valve assembly 116. Clogging of the annulus by particles in the water supply system is minimized because, when depressed, the needle valve 187 clears any foreign matter that lodges in the orifice 188.

Refill volume of the toilet bowl utilizing this existing metering actuator assembly can be varied by varying the diameter of the orifice 188 in conjunction with the diameter of the needle valve 187, which varies the ratio of water passed into zone “C” respectively, thus speeding or slowing movement of the piston 204 and closure of the valve of the flush valve assembly 116 after flushing and/or the amount of bowl refill water passed through the water vessel 114 to the toilet bowl (not shown). As a result, the system 110 can be precisely tuned to different bowl configurations to obtain maximum water conservation and performance. The present invention provides an external manual adjustment for the bowl refill volume.

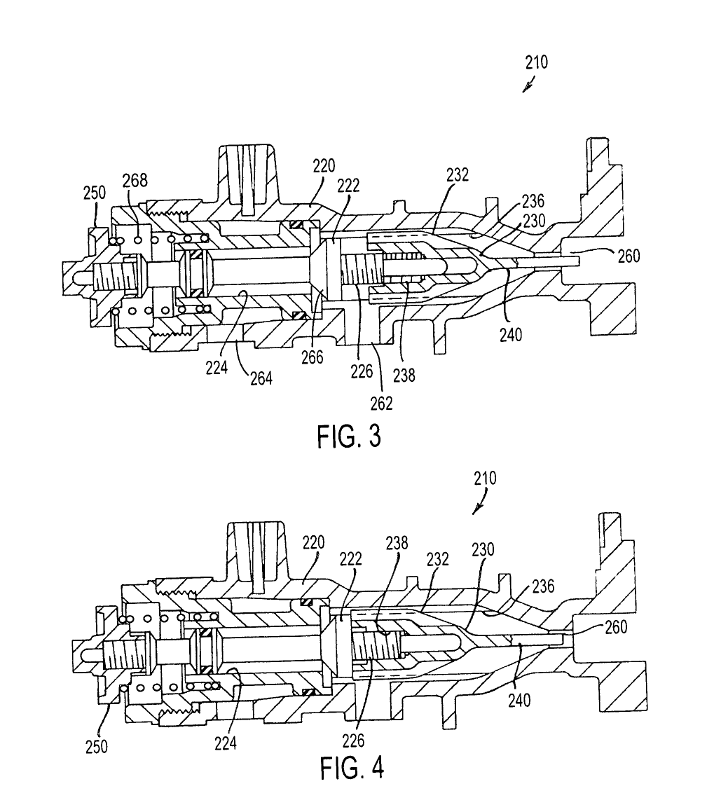

Referring to FIGS. 3 and 4 and in accordance with the invention, an adjustable metering actuator assembly 210 comprises a generally cylindrical housing 220 with a manually operable spool valve member (hereafter “spool”) 222 disposed internally thereof that is slidably journaled on a sleeve 224. The spool 222 has an externally threaded portion 226 at one end thereof that rotatably engages a generally right circular cylindrical valve stem 230. In a preferred embodiment, housing 220 defines an inlet 262, through which water from zone C can enter housing 220 during a flush event, when used in conjunction with a pressurized water closet, for instance, the water closet described herein. The housing 220 further defines an outlet 264, for discharge of water to zone F. Between flushes, the spool 222 is preferably biased against a seat 266 by action of a biasing spring 268 acting on the knob 250, and thereby blocks fluid communications between the inlet 262 and the outlet 264. When a flush event is initiated, knob 250 is pushed axially inward relative to housing 220, lifting the spool 222 from the seat 266, and establishing fluid communication between the inlet 262 and the outlet 264.

The valve stem 230 is slidably journaled in the cylindrical housing 220 and has a plurality of longitudinal grooves or slots 232 therein, that engage a plurality of splines or tabs 236 protruding from the interior of the housing 220, restricting or preventing rotation of the valve stem 230 with respect to the housing 220. The valve stem 230 further has an internally threaded portion 238 that is engaged by the externally threaded portion 226 of the spool 222.

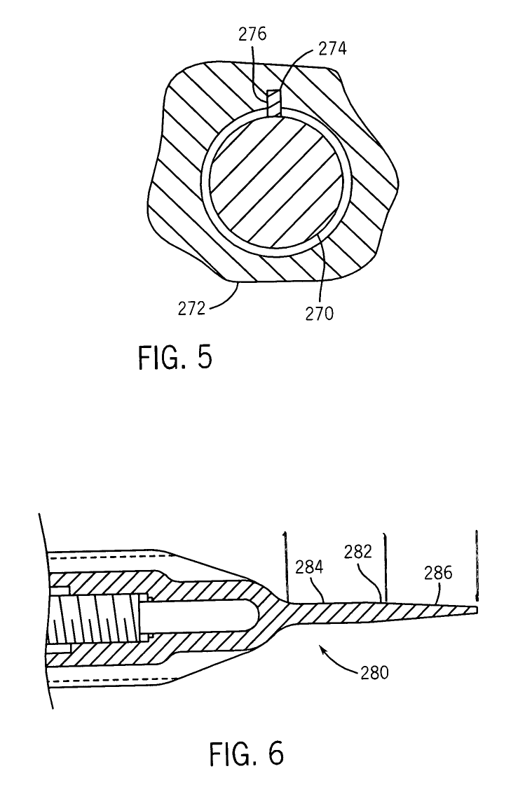

An alternative embodiment is shown in FIG. 5 which illustrates a section view of a control valve. In the embodiment shown in FIG. 5, a splined valve stem 272 is shown positioned within a housing 270. The valve stem 272 includes at least one longitudinal spline 276 that is received in a groove 274 in the housing 270.

Various modifications, including the number of spline-groove pairs, the dimensions of the splines and grooves, etc., can be made to the embodiment shown in FIG. 5 without departing from the scope of the present invention, so long as the valve stem 272 is “limited in rotation in the housing”. Still further embodiments utilize a square, oval or otherwise non-circular valve stem, and the rotation-limiting features disclosed herein should therefore not be taken to limit the scope of the present invention. It is only necessary that the respective shapes of the housing 220 and the valve stem 230 be such that the valve stem 230 cannot rotate therein when the spool 222 is rotated by manipulation of the knob 250.

Alternatively, the spool can be fixed from rotation, and a valve stem rotatable with respect to the housing. A rod can be positioned in a longitudinal bore in the spool and connected to the external knob. In such embodiment, the valve stem can be fixedly mounted to the rod and axially adjusted by a threaded engagement of the rod with the longitudinal bore in the spool. In a manner similar to other disclosed embodiments, such a design would allow actuation of the internal flush valve assembly in response to inward displacement of the external knob 250, lifting the spool from its seat and opening fluid communication past seat 266.

Referring again to FIGS. 3 and 4, the spool 222 is rotated by the manual adjustment knob 250. As the spool 222 rotates, the valve stem 230 is restricted from rotation, and thus is driven by the rotation of the spool threads to slide inwardly or outwardly, depending upon the direction of rotation. Although the illustrated embodiments include an internally threaded valve stem and an externally threaded spool, this relationship can be reversed without departing from the scope of the present invention. A needle valve pin 240 is supported on one end of the valve stem 230 so as to extend into an orifice 260 in the housing 220 to define the area of an annular water inlet orifice that controls the flow of water to, for example, a flush valve in a water closet. The maximum diameter of the needle valve pin 240 is less than the diameter of the orifice 260 such that fluid communication therethrough is not interrupted by the action of the valve.

The orifice 260 in conjunction with the needle valve pin 240 of the instant invention minimizes the lodging of any foreign matter in the orifice 260 as the needle valve pin 240 can be readily advanced therein to clear any obstruction. Needle valve pin 240 can be readily advanced past the orifice 260 to clear any obstruction therein. As used herein, the term “orifice” should be understood as referring to the three-dimensional, narrowed region of the housing 220 into which the needle valve pin 240 can extend.

When an adjustable flush valve actuator according to the present invention is used in conjunction with a pressurized water closet, as for example disclosed in U.S. Pat. No. 5,970,527 to Martin, et al., the refill volume of a toilet bowl can be varied by varying the diameter of the orifice 260 by advancing the needle valve pin 240 therein, which varies the volume of water passed into a pressurized chamber of the water closet (not shown) to obtain maximum water conservation and performance. The depth of penetration of the needle valve pin 240 in orifice 60 affects a fluid flow rate therethrough. Further, the needle valve pin may be tapered to allow for a more dramatic variation of volume control for a given rotation of the control knob.

An illustrative embodiment of a valve stem 280 having a tapered needle valve pin 282 which can be used in the adjustable metering actuator assembly 210 of FIG. 3 is shown in FIG. 6. The metering valve is a spring-loaded, toggle-type valve that provides a timing or metering operation in addition to flow/no-flow control operation. A portion of the tip of the needle valve pin 282 is straight to permit zero-to-maximum fluid flow, allowing maximum range of adjustment. Thus, the needle valve pin 282 includes a straight portion or fixed diameter portion 284 and a tapered portion 286. The fixed diameter portion 284 of the needle valve pin 282 is used in providing the tapered portion 286 of the needle valve pin 282 is used in providing the metering function. The maximum outer diameter of the needle valve pin 282 is less than the inner diameter of the orifice. Thus, with the needle valve pin 282 fully extended, restriction is maximum and the fixed or non-tapered portion 284 of the pin engages the inner surface of the orifice and restriction is maximum. Other degrees of taper and lengths of the tapered region can be utilized in other embodiments (not shown), depending on the desired performance characteristics. For instance, where a particularly dramatic difference in refill volume is desired for a given rotation of the control knob 250, the needle valve pin 240 can be designed with a relatively short length of the tapered region, and a relatively steep degree of tapering. Further, use of tapered pins having flattened end surfaces is contemplated, similar to the pins shown in FIGS. 3 and 4, as well as embodiments having pins that taper to a point, as in a conventional needle valve. Still other embodiments (not shown) can utilize a straight/cylindrical needle valve pin in conjunction with a tapered orifice that narrows in a direction away from the valve stem, to achieve a similar effect. Again, in such an embodiment significant variation in the dimensions and degree of the tapered region can exist without departing from the scope of the present invention.

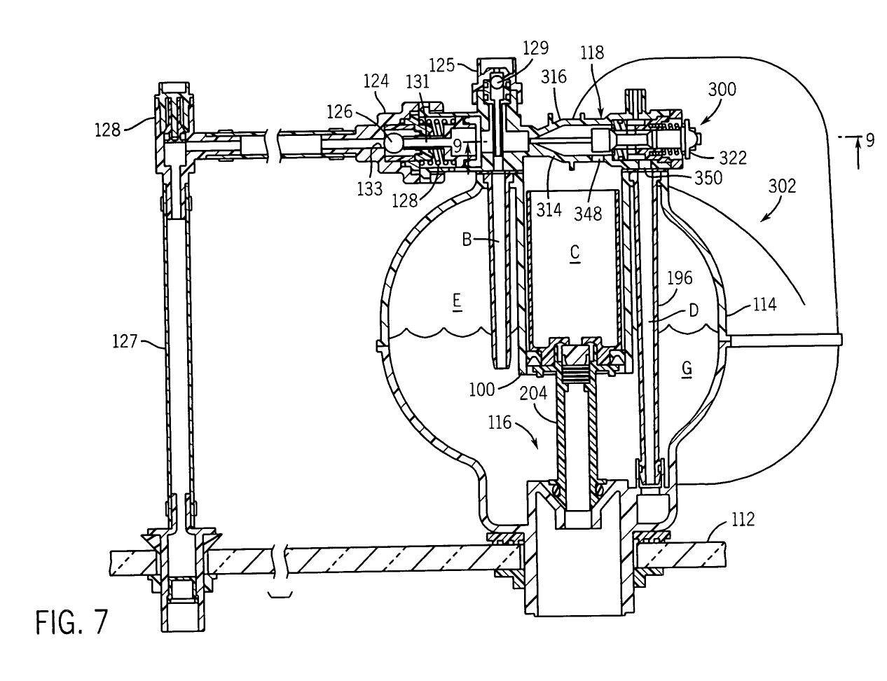

Referring to FIG. 7, a further embodiment of an adjustable metering actuator assembly 300 according to the invention is shown incorporated into a pressurized water closet flushing system 302 shown disposed in operative association with a conventional water closet tank 112. Other elements of the pressurized water closet flushing system 302 can be similar to elements of the pressurized water closet flushing system 110 described above with reference to FIG. 1. Accordingly, some of the elements of the pressurized water closet flushing system 302 have been given the same reference numerals as corresponding elements of the pressurized water closet flushing system 110.

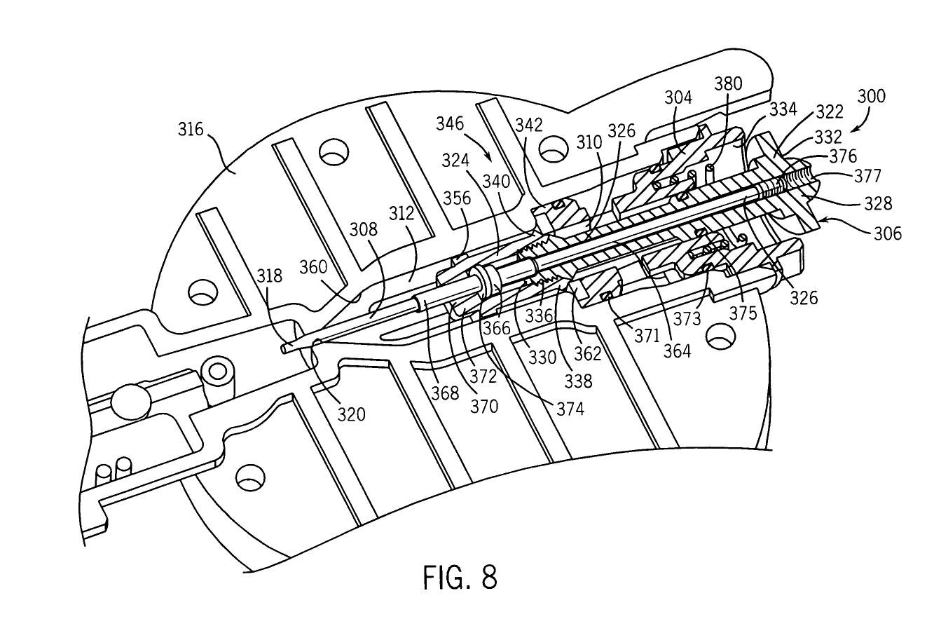

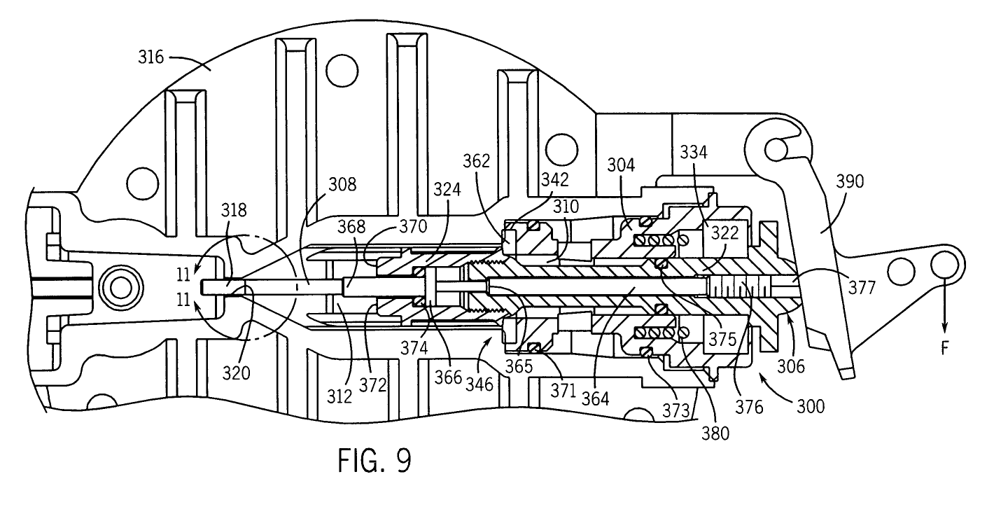

Referring also to FIGS. 8 and 9, the metering actuator assembly 300 includes a valve housing 304 and a plunger assembly 306, including a needle valve pin 308, which is slidably mounted within a central bore 310 of the valve housing 304 for reciprocating movement relative to the valve housing 304. The metering actuator assembly 300 is located within a cavity 312 of a housing 313 defined by a base portion 314 and a cap portion 316 of the manifold 118. The distal tip 318 of the needle valve pin 308 is located adjacent to an inlet orifice 320, defined by the manifold 118, to control the flow rate through the inlet orifice 320. The portion of the end of the needle valve 308 that is located adjacent the inlet orifice 320 is of varying diameter. The dimensions of the needle valve pin and the inlet orifice determine the shut-off time for the flush valve assembly 116. As will be shown, the needle valve pin 308 is axially repositionable with respect to a plunger actuator 322 to thereby adjust the fluid flow rate through the inlet orifice 320 and thus the refill volume of the bowl. The needle valve pin 308 is supported within the housing for axial movement along the axis of the plunger actuator 322.

The plunger assembly 306 includes the plunger actuator 322 that carries a valve seat member 324. The plunger actuator 322 is supported within the housing for reciprocating axial movement. The plunger actuator 322 is an elongated member having an axial bore 326 that extends between the proximal end 328 and the distal end 330 of the plunger actuator 322. The proximal end 328 of the plunger actuator 322 includes an annular disk-shaped portion 332 that is disposed within a hollow recessed area 334 of the valve housing 304. The plunger actuator 322 has a threaded outer surface portion 336 at its distal end 330. The plunger actuator 322 and the valve seat member 324 can be made of stainless steel or other relatively rigid and non-corrosive material.

The valve seat member 324 is a hollow, generally cylindrical element having a threaded inner surface 338 that is engaged with the threaded outer surface 336 on the distal end 330 of the plunger actuator 322, securing the valve seat member 324 to the plunger actuator 322 to allow the valve seat member 324 to be reciprocated with the plunger actuator 322. The valve seat member 324 has a valve seat portion 340 that cooperates with a mating valve portion 342 on an inner surface of the valve housing 304, forming an actuator valve 346 that is interposed between the pressurized zone C and the inlet of the pressure relief tube 196, as shown in FIG. 7. It will be apparent to those skilled in the art that removably locating the valve seat on the plunger actuator facilitates maintenance of the actuator valve. However, in some embodiments, the valve seat can be formed on the inner surface of the housing and the mating valve portion can be carried by the plunger actuator.

The metering actuator assembly 300 has a fluid inlet 348 in fluid communication with the zone C and a fluid outlet 350 that is in fluid communication with the pressure relief tube 196. The valve seat member 324 has an annular flange that defines the valve seat portion 340. The valve seat member 324 has a further annular flange 356 that is dimensioned to engage the inner surface 360 of the central bore 310 for guiding the distal end 330 of the plunger actuator 322 as the plunger actuator 322 is reciprocated within the bore 310. The actuator valve 346 normally prevents fluid flow through the metering actuator assembly 300. The actuator valve 346 is operated to a fluid flow permitting condition at the start of a flush operation in response to operation of the metering actuator assembly 300, allowing water to flow through the metering actuating assembly 300 from the pressurized zone C to the pressure relief tube 196.

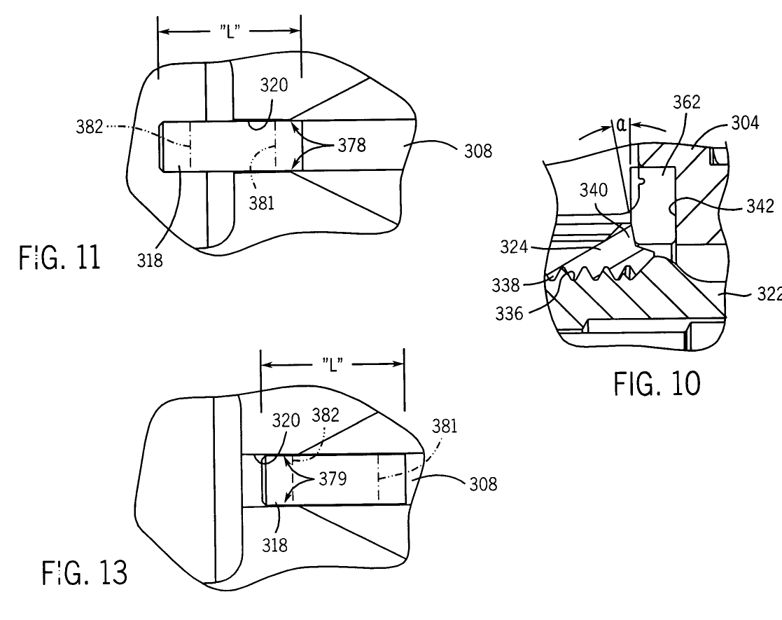

Referring to FIGS. 9 and 10, an O-ring seal 362 is mounted on the valve portion 342 of the valve housing 304 to prevent back flow through the internal thread 338 on the valve seat member 324 and the mating external thread 336 on the plunger 322. The O-ring seal 362 has a surface that presents an acute angle α with respect to the mating surface of the valve portion 342. Thus, at the interface of the O-ring seal 362 and the valve seat portion 340, the angle α is reduced at the seal. By way of example, the angle α can be on the order of about 5°. This reduces axial shift of the plunger assembly 306 due to compression set of the seal and provides less drift of the restriction adjustment over time.

Referring to FIGS. 8 and 9, the plunger assembly 306 further includes a push rod 364 that extends within the central bore 326 of the plunger actuator 322 and carries the needle valve pin 308. The push rod 364 has a stepped outer diameter, defining a shoulder 365 of a purpose to be shown. The needle valve pin 308 is attached to the distal end of the push rod 364 with the distal tip 318 of the needle valve pin 308 located adjacent to the inlet orifice 320. The needle valve pin 308 has an enlarged proximal end portion 366 that is located within the hollow valve seat member 324 for retaining the proximal end portion 366 within the valve seat 324. The shank portion 368 of the needle valve pin 308 extends through an aperture 370 in the forward end 372 of the valve seat member 324. An O-ring 374 is mounted on the push rod 364 located between the enlarged proximal end portion 366 of the needle valve pin 308 and the forward end 372 of the valve seat member 324.

The O-ring seals 362 and 374 substantially eliminate the leak path through the mating threads 336 and 338 of the plunger actuator 322 and the valve seat member 324. The O-ring seal 374 seals the needle valve pin 308 within the valve seat member 324 and eliminates a leak path that bypasses the interface between the valve seat member 324 and the seal when the metering actuator assembly 300 is in the closed condition. Further O-ring seals 371 and 373 are provided between the outer surface of the valve housing 304 and the inner surface of the cap 316 (and base 314) and an O-ring seal 375 is provided between the inner surface of the valve housing 304 and the outer surface of the plunger actuator 322.

Referring to FIGS. 8, 9 and 11, the distal tip 318 of the needle valve pin 308 is tapered. The taper length “L” can be 0.255 inches. Preferably, the end surface of the distal tip 318 of the needle valve pin 308 can be blunt as shown in FIGS. 8 and 11 for example. In the embodiment illustrated in FIGS. 8 and 9, taper points of the needle valve pin 308, corresponding to tapers of 0.087 inch and 0.084 inch, respectively, are indicated by respective reference numerals 381 and 382 in FIGS. 11 and 13. These points are spaced apart about 0.136 inch apart axially. However, other degrees of taper and lengths of the tapered region can be utilized, depending on the desired performance characteristics. For instance, where a particularly dramatic difference in refill volume is desired, the needle valve pin 308 can be designed with a relatively short length for the tapered region and a relatively steep degree of tapering. Further, the tapered pin can have flattened end surfaces similar to the pins shown in FIGS. 3 and 4 or can taper to a point, as in a conventional needle valve. Alternatively, the needle valve pin can be a straight/cylindrical pin and the inlet orifice can be a tapered orifice that narrows in a direction away from the plunger actuator (i.e., to the left in FIG. 9), to achieve a similar effect. Again, in such an embodiment, significant variation in the dimensions and degree of the tapered region can exist without departing from the scope of the present invention.

The closing speed of the flush valve assembly 116 is governed by flow restriction created by the tapered distal tip 318 of the needle valve pin that interacts with the inlet orifice 320. In accordance with one aspect of the invention, the flow rate through the inlet orifice 318 of the metering actuator assembly 300, and thus, the shut off time for the flush valve assembly 116, can be adjustable by repositioning the push rod 364 and the needle valve pin 308 carried by the push rod 364 axially on the plunger actuator 322. Axially repositioning the needle valve pin 308 changes the diametral clearance between the tapered portion of the needle valve pin 308 and the inner diameter of the inlet orifice. Thus, the adjustment of the axial position of the tip 318 of the needle valve pin 308 relative to the inlet orifice 320 changes the flow rate through the inlet orifice 320. To this end, the metering actuator assembly 300 includes an adjustment member, such as a setscrew 376, that is mounted in a tapped bore 377 in proximal end of the plunger actuator 322. The setscrew 376 is accessible from the exterior of the housing and is rotatable in one direction to advance the push rod 364 axially toward the inlet orifice 320, adjusting the axial position of the needle valve pin 308 within the central bore 314. The push rod 364 and the needle valve pin 308 are not connected to the setscrew. However, when the setscrew is rotated in the opposite direction (i.e., backed out), the push rod 364 and the needle valve pin 308 will follow the setscrew 376 because water pressure will push the three parts to mate end-to-end. The setscrew 376 is accessible through the open upper end of the plunger actuator 322, allowing adjustment in the position of the push rod 364 and thus the position of the tapered distal end 318 of the needle valve pin 308.

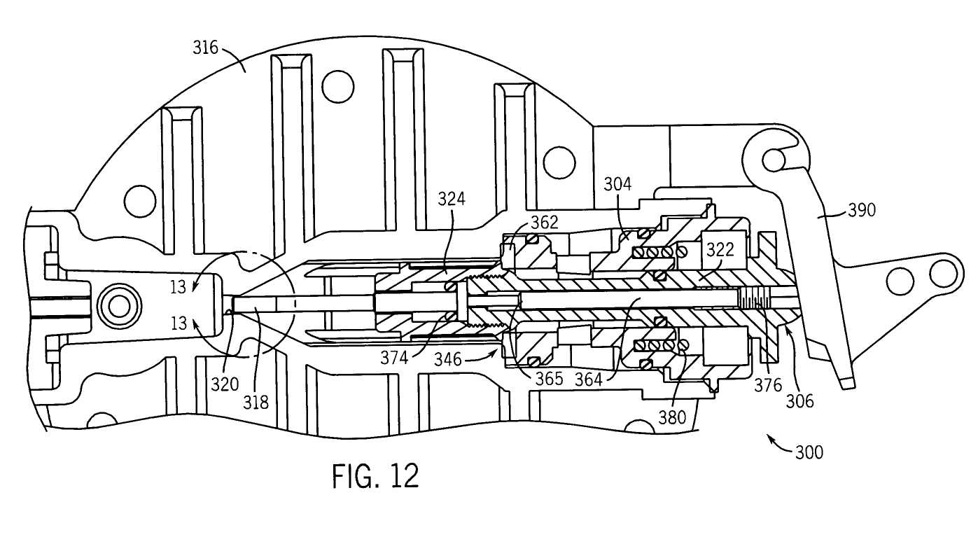

FIGS. 9 and 11 illustrate the needle valve pin maximally extended with respect to the inlet orifice 320, providing a minimum flow rate through the inlet orifice 320. Conversely, FIGS. 12 and 13 illustrate the needle valve pin minimally extended with respect to the inlet orifice 320, providing a maximum flow rate through the inlet orifice 320.

In the embodiment illustrated in FIGS. 8-9, the taper points 381 and 382 of the needle valve pin 308 correspond to taper dimensions 0.087 inch and 0.084 inch (points 381 and 382, respectively). These points are spaced apart about 0.136 inch apart axially. The setscrew 376 has thirty-two threads per inch. Consequently, the needle valve pin 308 advances about 0.031 inch for each complete turn of the setscrew 376. This correlates to about 4.4 turns between 0.087 inch and 0.084 inch. The range of adjustment of the needle valve pin 308 is 0.200 inches. Thus, 6.4 total turns of adjustment for the setscrew 376 provide a full 0.200 inch of travel for the needle valve pin 308. The dimensions in the foregoing description are by way of example only and the taper portion of the needle valve pin can have different dimensions.

As the setscrew 376 is turned in one direction, clockwise, for example, the needle valve pin 308 is advanced (i.e., repositioned axially in a direction toward the inlet orifice) and the tapered distal tip 318 of the needle valve pin 308 will be moved deeper into the restricting bore 320. Accordingly, more restriction is created due to reduction of diametral clearance between the distal tip 318 of the needle valve pin 308 and the restricting bore formed by the inlet orifice 320. The throttling point is at location 378, shown in FIG. 11, due to the diametral clearance between the needle valve pin 308 and the inlet orifice 320. With the plunger assembly 306 axially adjusted to the position shown in FIGS. 9 and 11, the distal tip 318 of the needle valve pin 308 is maximally extended with respect to the inlet orifice 320, providing minimum flow rate through the inlet orifice 320, increasing the turn off time for the flush valve assembly 116 (FIG. 7). At this setting, the flow restriction area is the greatest. During such adjustment, the shoulder 365 (FIG. 9) of the push rod 364 and the distal end 330 of the plunger actuator 322 cooperate to limit the axial movement of the push rod 364 as the setscrew 376 is tightened (advanced).

Turning the setscrew 376 in the opposite direction, counterclockwise, for example, causes the needle valve pin 308 to be retracted (i.e., repositioned axially in a direction away from the inlet orifice) and the tapered distal tip 318 of the needle valve pin 308 is moved out of the restricting bore 320. Accordingly, less restriction is created due to increase in the diametral clearance between the tip of the needle valve pin 308 and the restricting bore 320. The throttling point is at location 379, shown in FIG. 13, due to the diametral clearance between the needle valve pin 308 and the bore 320. At this setting, the flow restriction area is the smallest. With the plunger assembly 306 in the position shown in FIGS. 12 and 13, the distal tip 318 of the needle valve pin 308 is retracted with respect to the inlet orifice 320, providing an increased flow rate through the inlet orifice 320 relative to the flow rate for the setting illustrated in FIGS. 9 and 11, decreasing the turn off time for the flush valve assembly 116 (FIG. 7). Travel limit for adjustment in this direction is provided by the end of the plunger actuator 322. Specifically, further outward travel of the needle valve pin 308 for axially repositioning of the needle valve pin 308 is prevented when the rearward surface of the head portion 366 of the needle valve pin 308 engages the distal end 330 of the plunger actuator 322.

Referring to FIGS. 8 and 9, a bias spring 380 is located within the recessed area 334 of the valve housing 304 interposed between a surface and the end surface of the plunger actuator 322. The bias spring 380 maintains the plunger assembly 306 in the position shown in FIGS. 8 and 9. The plunger assembly 306 is movable against the force of the bias spring 380 to the depressed condition (not shown) in which the actuator valve 346 is opened, communicating the zone C with the pressure relief tube 196. The metering actuator assembly 300 can include a bell crank 390 (FIG. 9) pivoted to the cover 314 and adapted to pivot, pushing the plunger actuator 322 inwardly (to the left in FIG. 9) in response to the application of a downward force F to an outwardly projecting portion of the bell crank 390 as shown in FIG. 9, for example. The plunger assembly 306 is restored to the closed condition under the force of the bias spring 380 upon release of the plunger actuator 322.

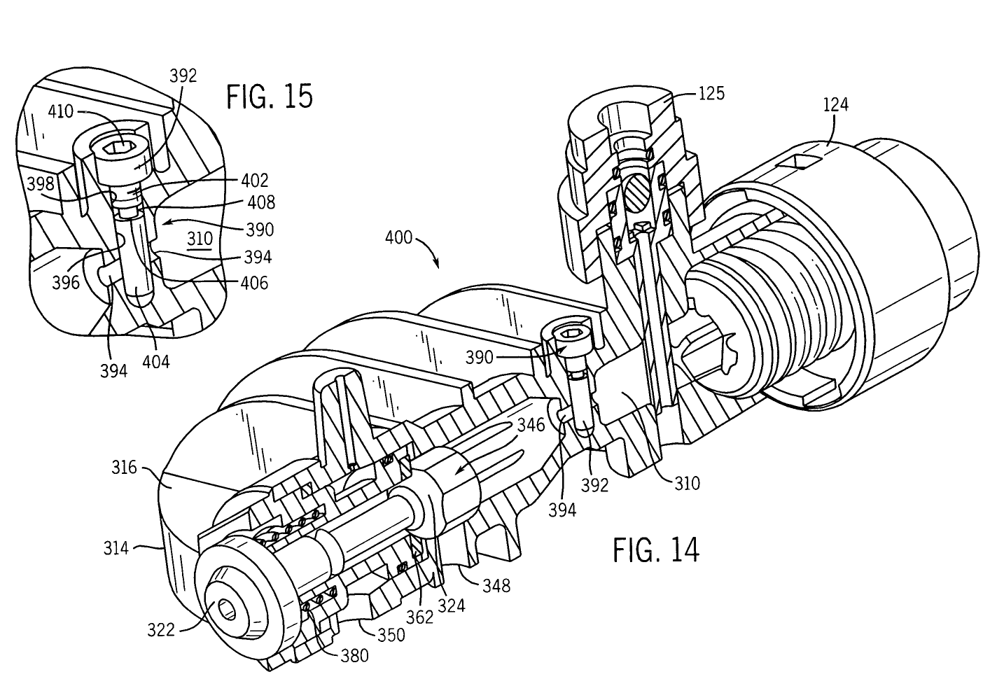

Referring to FIG. 14, in an embellishment, the plunger assembly 306 (FIG. 7) of the metering actuator assembly 300 can be modified to incorporate a needle jet valve 390 in place of the needle valve pin 308. The metering actuator assembly 400 incorporating a needle jet valve 390 is similar to the metering actuator assembly 300 shown in FIGS. 7-13 and accordingly, corresponding components have been given the same reference number.

In the metering actuator assembly 400, the needle jet valve 390 includes a needle jet pin 392 that extends normal to the axis along which the plunger actuator 322 moves for moving a valve seat member 324 for operating the actuator valve 346 to communicate the fluid inlet 348 with the fluid outlet 350. Referring also to FIG. 15, the water pressure regulator 124 is communicated with the actuator valve 346 through a channel 310 defined by the base 314 and the cap 316. A portion 394 of the channel 310 is restricted. The needle jet pin 392 interrupts the restricted portion, or inlet orifice, 394 of the channel 310.

More specifically, with reference to FIGS. 14 and 15, the needle jet pin 392 extends within a passageway 396 having a tapped inner wall 398 that is engaged by a threaded shaft portion 402 of the needle jet pin 392. The distal end 404 of the needle jet pin 392 is located adjacent to the inlet orifice 394 and is generally conical in shape such that the outer diameter of the conical shaft portion decreases from top to bottom. Thus, the needle jet pin 392 can be rotated clockwise and counterclockwise to advance or withdraw the conical distal end 404 of the needle jet pin 392 with respect to the inlet orifice 394, decreasing or increasing, respectively, the flow rate through the inlet orifice 394. Adjustment of the axial position of the end 404 of the needle jet pin 392 relative to the inlet orifice 394 effectively changes the flow rate through the inlet orifice 394 in a manner similar to the change in flow rate through the inlet orifice 320 (FIG. 8) as a function of the axial position of the tapered distal tip 318 of the needle valve pin 308. The shaft of the jet needle pin 392 has a groove 406 that receives an O-ring 408 for providing a seal between the inlet orifice 394 and the exterior along the needle jet pin 392. The needle jet pin 392 has a socket head 410 to facilitate rotating the needle jet pin 392 to adjust the flow rate through the inlet orifice 394.

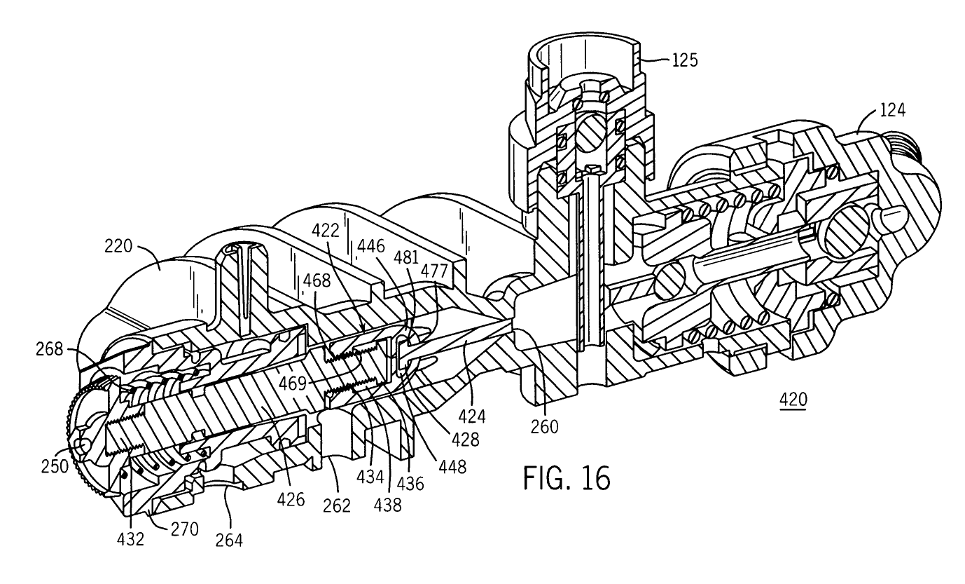

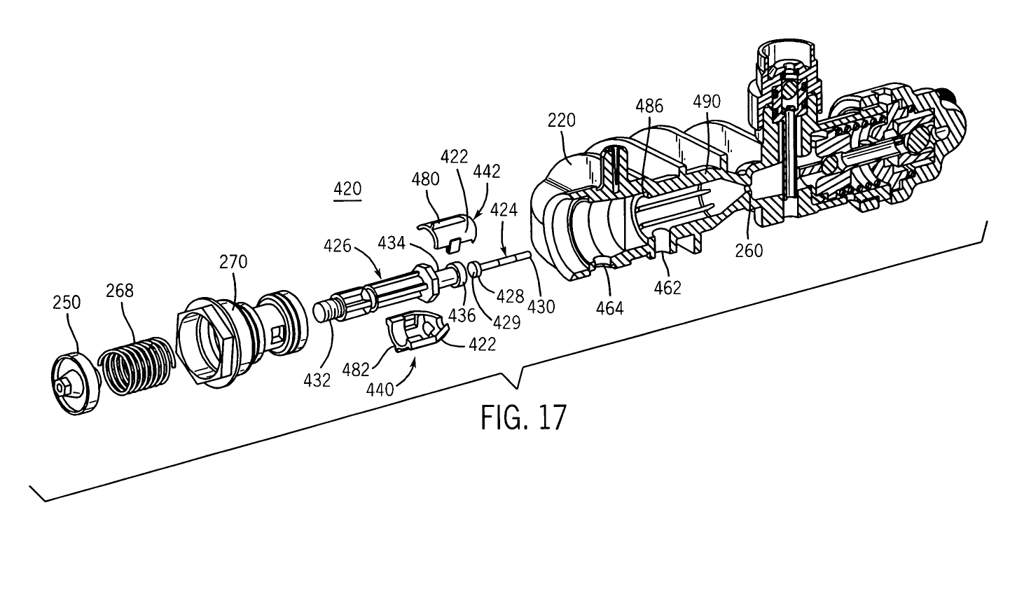

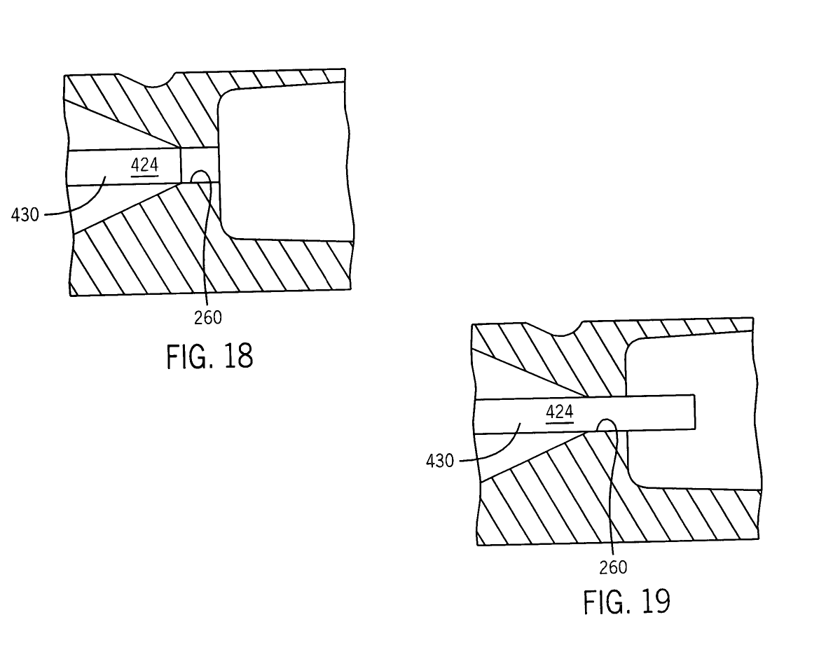

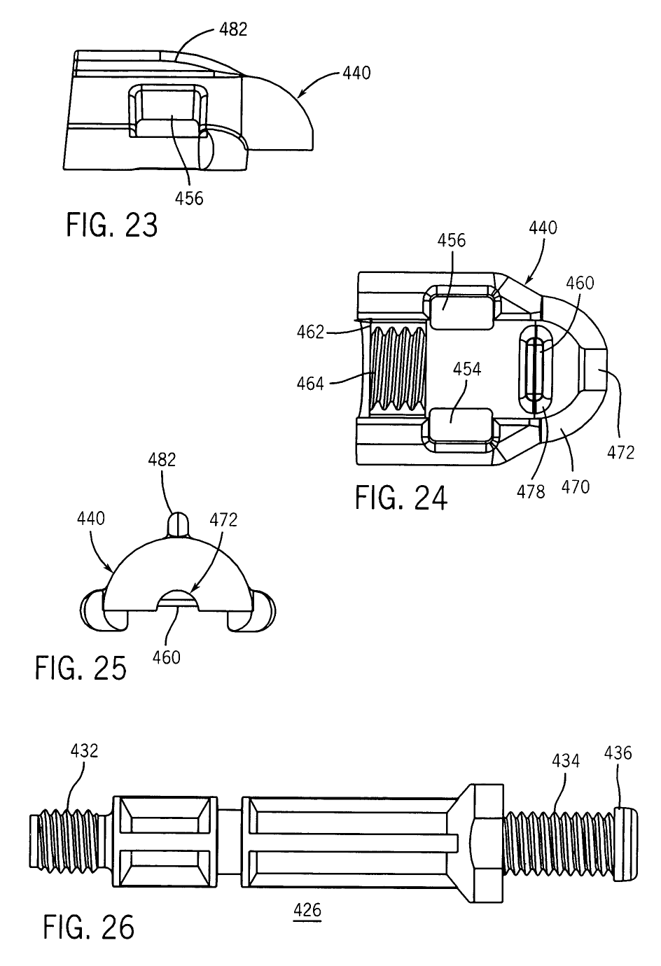

Referring to FIGS. 16 and 17, in accordance with a further embellishment, the metering actuator assembly 210 shown in FIGS. 3 and 4 can be modified to have the metering or needle valve pin coupled to the actuator stem rather than be formed integrally with the actuator stem. The modified metering actuator assembly 420, shown in FIGS. 16 and 17, includes a needle valve pin holder 422 that couples a separate needle valve pin 424 to the actuator stem 426. The components and operation of the metering actuator assembly 420 are generally similar in structure and function to the metering actuator assembly 210 shown in FIGS. 3 and 4 and new or modified components are identified by new reference numbers in FIGS. 16 and 17, as well as in FIGS. 18-26. Other components of the metering actuator assembly 420 have been given the same reference number as corresponding components of the metering actuator assembly 210 shown in FIGS. 3 and 4. The metering actuator assembly 420 can be incorporated into the pressurized water closet flushing system 302 shown in FIG. 7, for example, as well as in other pressurized water closet flushing systems.

The needle valve pin 424 includes a shank with an enlarged end portion 428 at one end and a distal tip 430 at the opposite end. The distal tip 430 of the needle valve pin 424 is located adjacent to the inlet orifice 260, defined by the housing 220, to control the flow rate through the inlet orifice 260 as described with reference to FIGS. 3 and 4, for example. The distal tip portion of the needle valve pin 424 that is located adjacent the inlet orifice 260 is of varying diameter. The dimensions of the needle valve pin and the inlet orifice 260 determine the shut-off time for the flush valve assembly 116 (FIG. 7). By way of example, and without limitation, the dimensions of the needle valve pin 424 can correspond to those for the needle valve pin 308 described above with reference to FIGS. 8-13. The needle valve pin 424 is axially repositionable with respect to the actuator stem 426 to thereby adjust the fluid flow rate through the inlet orifice 260 and thus the bowl refill volume of the pressurized water closet. The needle valve pin 424 can be repositioned axially by turning the adjustment dial 250.

The distal tip 430 of the needle valve pin 424 can be tapered in the manner of the needle valve pin shown in FIGS. 6 and 8-12, for example. However, other degrees of taper and lengths of the tapered region can be utilized in other embodiments (not shown), depending on the desired performance characteristics. For instance, where a particularly dramatic difference in refill volume is desired for a given rotation of the control knob 250, the needle valve pin 424 can be designed with a relatively short length of the tapered region, and a relatively steep degree of tapering. Further, use of tapered pins having flattened end surfaces is contemplated, similar to the pins shown in FIGS. 3 and 4, as well as embodiments having pins that taper to a point, as in a conventional needle valve. Still other embodiments (not shown) can utilize a straight/cylindrical needle valve pin in conjunction with a tapered orifice that narrows in a direction away from the valve stem, to achieve a similar effect. Again, in such an embodiment significant variation in the dimensions and degree of the tapered region can exist without departing from the scope of the present invention.

Referring also to FIG. 26, the actuator stem 426 includes a threaded portion 432 at its proximal end and includes a further threaded portion 434 at its distal end. The distal tip of the actuator stem 426 includes an enlarged end portion or radial flange 436. The adjustment knob or dial 250 is mounted on the threaded end 432 of the actuator stem, providing for axial repositioning of the needle valve pin 424. The holder 422 engages at least a portion of the needle valve pin 424 to couple the needle valve pin to the actuator stem 426 while substantially preventing movement of the needle valve pin relative to the holder. The holder 422 and the needle valve pin 424 are repositionable with respect to the actuator stem 426 along an axis the extends along the longitudinal axis of the actuator stem 426. As will be shown, the holder 422 and the actuator stem 426 include mating threaded surfaces that cooperate to provide relative axial movement of the holder 422 relative to the actuator stem 426.

In the metering actuator assembly 420, the holder 422 is a two-part device that includes a base 440 and a mating cover 442. The base 440 and the cover 442 of the holder 422 snap together over the threaded end portion 434 of the actuator stem 426 and the enlarged end portion 428 of the needle valve pin 424 to secure the cover 440 to the base 442 with the enlarged end portion 428 of the needle valve pin 424 trapped within the forward end 446 of the holder 422 as shown in FIG. 16 so that the enlarged end portion 428 of the needle valve pin 424 is held by the holder. When assembled together, the base 440 and the cover 442 of the holder 422 with inwardly extending projections 460 and 461 (FIGS. 24 and 21) of the base 440 and cover 442 defining internal cavities 438 and 448 (FIG. 16). One cavity 438 contains a portion of the threaded end portion 434 of the actuator stem 426, including the radial flange 436. The other cavity 448 contains the enlarged end portion 428 of the needle valve pin 422, coupling the needle valve pin 424 to the actuator stem 426 so that the needle valve pin 424 moves with the holder 422.

In accordance with the invention, the holder 422 provides a dual function. The holder 422 couples the needle valve pin 424 to the valve stem 426 as described above. In addition, the holder 422 cooperates with the actuator stem 426 to prevent the holder 422 from slipping off the actuator stem 426 during repositioning of the holder 422 and needle valve pin 424. More specifically, as shown in FIG. 16, for example, the outer diameter of the radial flange 436 is greater than the diameter of the threaded opening 468 of the holder 422. Thus, the distal end of the actuator stem 426 is trapped within the cavity 438. Consequently, upon adjustment of the actuator stem 426 in a direction (to the left in FIG. 16) for retracting the needle valve pin 424, eventually the radial flange 436 will engage the inner surface 469 of the holder 422 surrounding the opening 468 which acts as a travel limit in one direction. With adjustment of the actuator stem 426 in the opposite direction, for extending the needle valve pin 424, the radial flange 436 will eventually engage inwardly extending projections 460 and 461 which acts as a travel limit in the opposite direction. The cavity 438 (FIG. 16) within the holder 422 defines the length of travel of the actuator stem 426 with respect to the holder 422 and the amount of axial adjustment of the needle valve pin 424 relative to the orifice 260. Thus, the holder 422 limits the stroke in both directions.

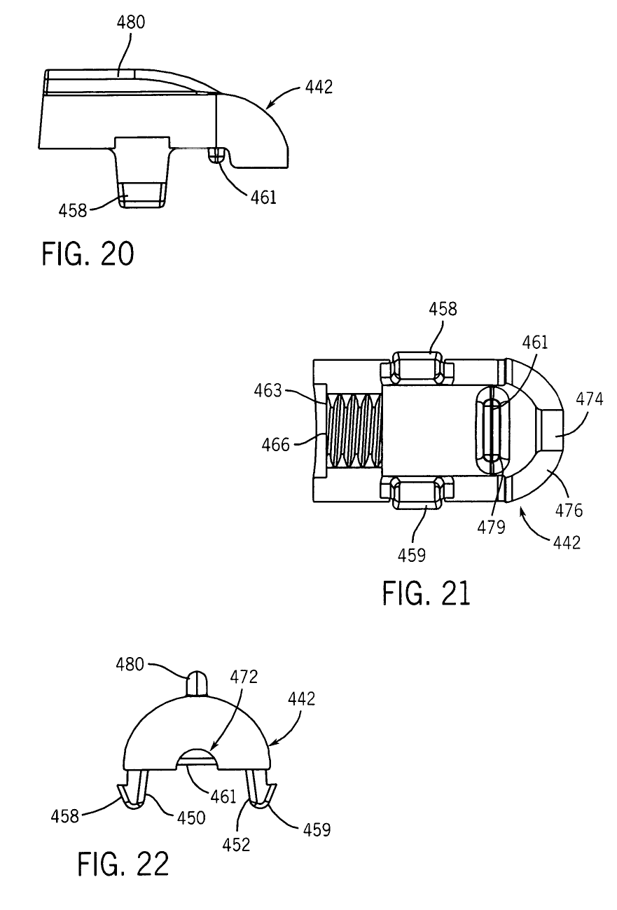

More specifically, referring also to FIGS. 20-22 and 24, the cover 440 has projections 450 and 452 that are received in mating openings 454 and 456 in the base 442. The projections 450 and 452 have hooked ends 458 and 459 that engage the base 442 to secure the cover 440 to the base 442. The holder 422 traps the end portion 428 of the needle valve pin 424, as shown in FIG. 16, between the forward ends of the cover 440 and base 442 of the holder 422 and inwardly extending projections 460 and 461 (FIGS. 21 and 24) on the base 440 and the cover 442, respectively, located spaced rearwardly of the forward end 446 of the holder 422. However, other connection mechanisms can be used to secure the cover 432 to the base 430.

Referring to FIGS. 16, 21, 24 and 26, internal surfaces 462 and 463 of the base 440 and the cover 442 are formed with respective thread portions 464 and 466 that mate to form a threaded opening 468 when the cover 432 is snapped onto the base 430 as shown in FIG. 16. The threaded opening 468 mates with the threaded end portion 434 of the actuator stem 426, defining a mechanism for causing the holder 422, and thus the needle valve pin 424, to be moved axially relative to the actuator stem 426 for repositioning the distal end of the needle valve pin 424 with respect to the inlet orifice 260.

Reference is now made to FIGS. 16, 21, 22, 24 and 25. The end 470 of the base 440 has a semicircular cutout or opening 472 that mates with a corresponding semicircular cutout opening 474 in the end 476 of the cover 442 when the base 430 and cover 432 are snapped together as shown in FIG. 16. The openings 472 and 474 cooperate to define an annular opening 477 at the forward end 446 of the holder 422 through with extends the needle valve pin 424. The surfaces of the holder around the annular opening 477 support the distal end portion of the needle valve pin 424 projecting forwardly of the holder 422 towards the inlet orifice 260. The opposite or enlarged end 428 of the needle valve pin 424 is supported by the holder 422, with at least a portion of the flat end surface 429 (FIG. 17) engaging the respective inner surfaces 478 and 479 of the projections 460 and 461 and at least the peripheral edge 481 of the opposite surfaces of the projections 460 and 461 engaging the inner surface 483 of the housing forward end 446.

Referring to FIGS. 16, 17, 20, 22, 23 and 25, the holder 422 has a longitudinally extending upper rib 480 and a longitudinally extending lower rib 482 that engage grooves or slots 486 and 488 in respective upper and lower interior surfaces 490 and 492 of the housing 220, for preventing rotation of the holder 422 with respect to the housing 220. The threaded opening 468 of holder 422 engages the externally threaded portion 434 of the actuator stem 426 as shown best in FIG. 16. Accordingly, as the actuator stem 426 is rotated by the adjustment dial 250, the holder 422, and thus the needle valve pin 424, are moved axially relative to the actuator stem 426. This repositions the tip 430 of the needle valve pin 424 with respect to the inlet orifice 260.

With reference to FIGS. 16 and 18, FIG. 18 illustrates the needle valve pin 424 minimally extended with respect to the inlet orifice 260, providing a maximum flow rate through the inlet orifice 260. As the adjustment dial 250 is turned in one direction, clockwise, for example, the needle valve pin 424 is advanced (i.e., repositioned axially in a direction toward the inlet orifice) and the tapered distal tip 430 of the needle valve pin 424 will be moved deeper into the restricting bore. Accordingly, more restriction is created due to reduction of diametral clearance between the distal tip 430 of the needle valve pin 424 and the restricting bore formed by the inlet orifice 260. With the actuator stem 426 axially adjusted to the position shown in FIG. 19, the distal tip 430 of the needle valve pin 424 is maximally extended with respect to the inlet orifice 260, providing minimum flow rate through the inlet orifice 260, increasing the turn off time for the flush valve assembly 116 (FIG. 7). At this setting, the flow restriction area is the greatest.

Turning the adjustment dial 250 in the opposite direction, counterclockwise, for example, causes the needle valve pin 424 to be retracted (i.e., repositioned axially in a direction away from the inlet orifice) and the tapered distal tip 430 of the needle valve pin 424 is moved out of the restricting bore 320. Accordingly, less restriction is created due to increase in the diametral clearance between the tip 430 of the needle valve pin 424 and the restricting bore. At this setting, the flow restriction area is the smallest. With the actuator stem 426 in the position shown in FIG. 18, the distal tip 430 of the needle valve pin 424 is retracted with respect to the inlet orifice 260, providing an increased flow rate through the inlet orifice 260 relative to the flow rate for the setting illustrated in FIG. 19, decreasing the turn off time for the flush valve assembly 116 (FIG. 7).

The operation of the pressurized water closet flushing system 302, including the metering actuator assembly 300, is now described with reference to FIGS. 7 and 27-29. Referring first to FIG. 7, initially, the vessel 114 is pressurized and ready to flush. The zones C and G and contain water at a pressure of about 22-25 psi. Similarly, the zone E contains air at a pressure of about 22-25 psi. The piston 131 of the water pressure regulator 124 is driven into engagement with the regulator ball 126 by the internal pressure of the vessel 114, urging the ball 126 onto the seat 133, shutting off the supply of water from supply line 127. The regulator spring 128 controls how much vessel pressure is required to shut off the supply line 127. Also, internal pressure of the vessel 114 maintains the ball 129 of the air pressure regulator 125 in a position closing the air inlet.

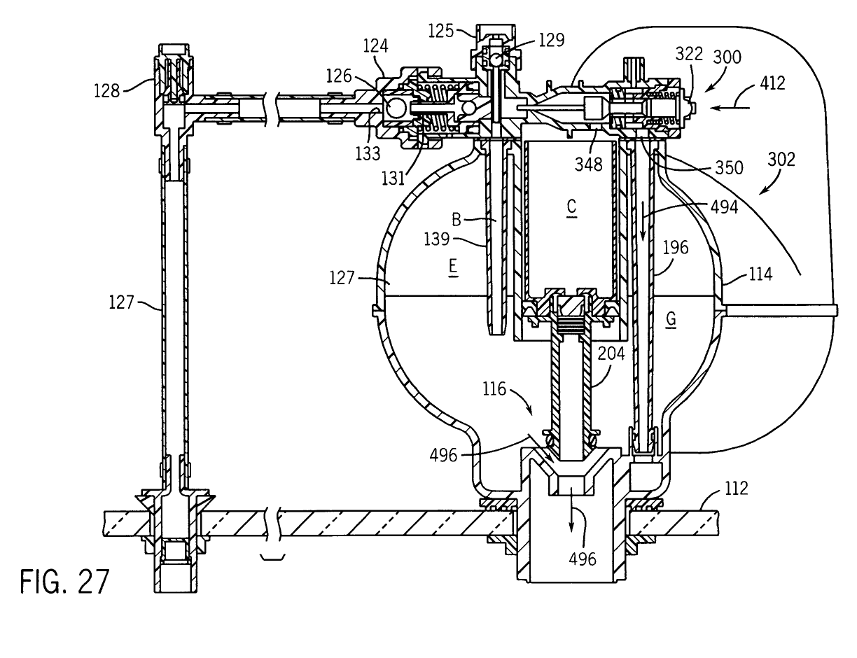

Referring to FIGS. 8 and 27, to initiate a flush, the plunger actuator 322 is pushed inwards in the direction of the arrow 412 (FIG. 27). This results in relative movement between the valve seat portion 340 and the valve portion 342, communicating zone C with the pressure relief tube 196, allowing water to flow through fluid outlet 350 from the zone C into the pressure relief tube 196 as represented by arrow 494. As water is being discharged, the pressure in zone C decreases relative to the pressure in zone G. As a result of the pressure differential created between zone C and zone G, the piston 204 of the flush valve assembly 116 is forced up by the pressure in the vessel 114, allowing water to flow through the annular seat of the flush valve assembly 116, as represented by arrows 496, to be discharged into the bowl through the now open flush valve assembly 116. The decreasing pressure in the vessel 114 allows piston 131 to move away from the ball 126 whereby the water pressure regulator 124 opens to flow permitting condition, allowing water from the supply line 127 to enter the vessel 114 through tube 139. In addition, the reduced pressure allows the ball 129 of the air inducer 125 to move off the inlet operating the air inducer regulator 125 to the open condition, allowing air into the vessel 114 so that both air and water now are entering the vessel 114 through zone B.

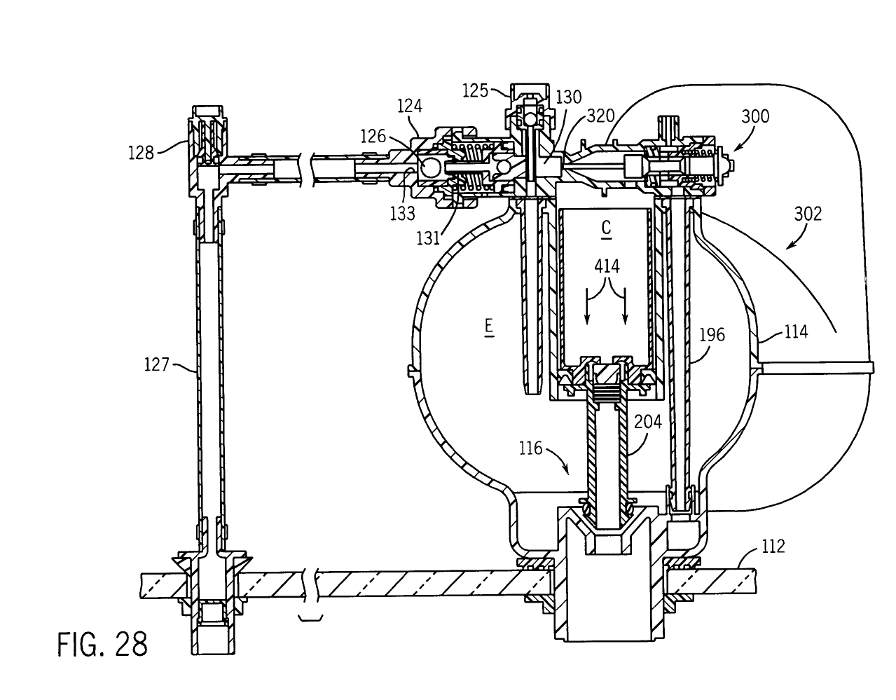

Referring to FIGS. 8 and 28, the actuator plunger assembly 306 is released to its closed position. Because the water pressure regulator 124 is open, water continues to flow into the vessel 114 through tube 139. Pressure is high in the area 130 forward of both the inlet orifice 320 to the upper chamber and the inlet orifice to the vessel chamber. Pressure and water are controlled into the flush chamber zone C through the metering actuator assembly 300. The clearance between the needle valve pin 308 and the inlet orifice 320 govern the fluid flow rate into the upper chamber, and thus the rate at which the flush valve lowers to eventually seal off against the seat, allowing the pressure to increase in both zones C E,. The flow rates allow the flush valve 116 to seal and the pressure keeps the flush valve sealed. When the pressure increases in zones C and E, a downward force represented by the arrows 414, causes the valve of the flush valve assembly 116 to be forced shut, allowing water and pressure to build within the vessel 114 to repressurize the vessel 114. The flush valve assembly is designed to provide a net downward force at a given pressure within zones C and E. The downward bias force 414 continues to oppose upward forces on the valve stem of the flush valve assembly.

As described above with reference to FIGS. 8, 9 and 11, for example, the flow rate through the inlet orifice 318 of the metering actuator assembly 300, and thus, the shut off time for the flush valve assembly 116, can be adjusted by repositioning the push rod 364 and the needle valve pin 308 axially on the plunger actuator 322. The setscrew 376 is accessible through the open upper end of the plunger actuator 322, allowing adjustment in the position of the tapered distal end 318 of the needle valve pin 308 to change the flow restriction and thus the closing speed of the flush valve assembly 116.

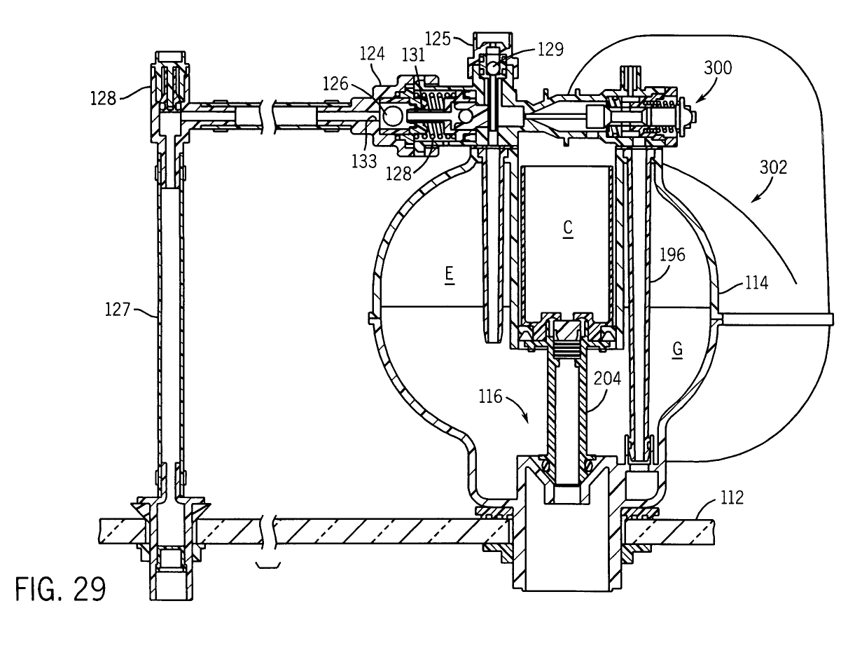

Referring to FIG. 29, with the valve of the flush valve assembly 116 shut, the water level and pressure in the vessel 114 increase. The air inducer ball 129 is pushed up due to the increase in pressure, sealing the vessel 114 from ambient air, allowing pressure to build within the vessel 114. As the pressure builds in the vessel 114, the piston 131 of the water pressure regulator 124 is driven forward. The pressure will reach a point where the piston 131 contacts the ball 126 which fully obstructs, stopping the flow from the supply 127 to the interior of the vessel 114. The vessel 114 is now repressurized and is ready to flush. The operation of a pressurized water closet flushing system incorporating the metering actuator assembly 400 is substantially the same as that for the pressurized water closet flushing system 302.

It may therefore be appreciated from the above detailed description of the preferred embodiment of the present invention that it provides a fluid metering actuator assembly a fluid metering actuator assembly that includes an actuator valve within a housing for operating a flush valve and a plunger slidably supported within the housing for operating the actuator valve. A needle valve pin is supported within the housing for axial movement relative to an inlet orifice defined by the housing. The needle valve pin is aligned with the inlet orifice and a portion of the needle valve pin that is located adjacent the inlet orifice has a varying diameter so that the axial position of the needle valve pin defines the fluid flow rate through the inlet orifice. The needle valve pin cooperates with the inlet orifice to define a refill volume of the bowl.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

1. A fluid metering actuator assembly for controlling the operation of a flush valve of a pressurized water closet, said fluid metering actuator assembly comprising:
a housing defining an inlet orifice;
an actuator valve within said housing, said actuator valve operable to operate the flush valve;
a plunger slidably supported within said housing for operating said actuator valve; and
a needle valve pin supported within said housing for axial movement relative to said plunger, said needle valve pin aligned with said inlet orifice, an axial position of said needle valve pin defining a fluid flow rate through said inlet orifice, at least a portion of said needle valve pin that is located adjacent said inlet orifice varying in diameter, said needle valve pin cooperating with said inlet orifice to define a bowl refill volume of said pressurized water closet.

2. The fluid metering actuator assembly according to claim 1, wherein closing speed of said flush valve is controlled by the fluid flow rate through said inlet orifice, and wherein said needle valve pin is axially repositionable with respect to said plunger to thereby adjust the fluid flow rate through said inlet orifice and thus, the bowl refill volume of said pressurized water closet.

3. The fluid metering actuator assembly according to claim 1, wherein said needle valve pin is axially repositionable to change diametral clearance between said portion of said needle valve pin and said inlet orifice to thereby adjust the fluid flow rate through said inlet orifice.

4. The fluid metering actuator assembly according to claim 1, wherein at least said portion of said needle valve pin is tapered.

5. The fluid metering actuator assembly according to claim 1, and including an adjustment member accessible from the exterior of said housing and operable to cause axial repositioning of said needle valve pin with respect to said plunger and said inlet orifice.

6. The fluid metering actuator assembly according to claim 5, wherein moving said needle valve pin axially towards said inlet orifice increases restriction of said inlet orifice, thereby decreasing the rate of fluid flow through said inlet orifice, and wherein moving said needle valve pin axially away from said inlet orifice decreases restriction of said inlet orifice, thereby increasing the rate of fluid flow through said inlet orifice.

7. The fluid metering actuator assembly according to claim 5, and further including a push rod interposed between said adjustment member and said needle valve member for moving said needle valve pin axially with respect to plunger.

8. The fluid metering actuator assembly according to claim 7, wherein said push rod is carried by said plunger and movable into engagement with said needle valve pin.

9. The fluid metering actuator assembly according to claim 7, wherein needle valve pin is movable axially relative to both said plunger and said push rod.

10. The fluid metering actuator assembly according to claim 1, wherein said needle valve pin is supported within said housing to be repositionable along a longitudinal axis of said plunger.

11. The fluid metering actuator assembly according to claim 1, wherein said needle valve pin is supported within said housing to be repositionable along an axis that extends normal to a longitudinal axis of said plunger.

12. The fluid metering actuator assembly according to claim 1, including a holder coupling said needle valve pin to said plunger.

13. The fluid metering actuator assembly according to claim 12, wherein said holder and said needle valve pin are repositionable with respect to said plunger along an axis the extends along the longitudinal axis of said plunger.

14. The fluid metering actuator assembly according to claim 12, wherein said holder includes first and second mating members, said holder engaging at least a portion of said needle valve pin to couple said needle valve pin to said plunger while substantially preventing movement of said needle valve pin relative to said holder, and said holder cooperates with said plunger to prevent said holder from slipping off said plunger during repositioning of said needle valve pin.

15. The fluid metering actuator assembly according to claim 5, wherein said plunger defines a limit stop for axially repositioning said needle valve pin in one direction.

16. The fluid metering actuator assembly according to claim 15, wherein said needle valve pin cooperates with said plunger to define a limit stop for axially repositioning said needle valve pin in a direction opposite to said one direction.

17. An adjustable fluid metering actuator assembly for controlling the operation of a flush valve of a pressurized water closet, said fluid metering actuator assembly comprising:
a housing defining an inlet orifice;
an actuator valve for operating said flush valve;
a plunger assembly slidably contained within said housing, said plunger assembly including a plunger for operating said actuating valve;
said plunger assembly further including a needle valve pin coupled to said plunger, said needle valve pin aligned with said inlet orifice, an axial position of said needle valve pin defining a fluid flow rate through said inlet orifice, wherein at least a portion of said needle valve pin adjacent said inlet orifice is tapered, said needle valve pin axially repositionable with respect to said plunger, to thereby adjust a bowl refill volume of said pressurized water closet.

18. The fluid metering actuator assembly according to claim 17, wherein said plunger assembly further includes a push rod carried by said plunger, said needle valve pin movable axially relative to both said plunger and said push rod.

19. The fluid metering actuator assembly according to claim 18, wherein said push rod is supported by said plunger and is movable axially for repositioning said needle valve pin axially relative to said plunger.

20. The fluid metering actuator assembly according to claim 19, and including an adjustment member accessible from the exterior of said housing and operable to move said push rod to cause axial repositioning of said needle valve pin with respect to said plunger and said inlet orifice.

21. The fluid metering actuator assembly according to claim 17, wherein said needle valve pin is supported within said housing to be repositionable along a longitudinal axis of said plunger.

22. The fluid metering actuator assembly according to claim 17, wherein said needle valve pin is supported within said housing to be repositionable along an axis that extends normal to a longitudinal axis of said plunger.

23. The fluid metering actuator assembly according to claim 17, including a holder coupling said needle valve pin to said plunger.

24. The fluid metering actuator assembly according to claim 23, wherein said holder and said needle valve pin are repositionable with respect to said plunger along an axis the extends along the longitudinal axis of said plunger, and said holder cooperates with said plunger to prevent said holder from slipping off said plunger during repositioning of said holder and needle valve pin.

25. The fluid metering actuator assembly according to claim 23, wherein said plunger is rotatable relative to said housing, and wherein said holder is coupled to said plunger and is movable axially relative to said plunger in response to rotational movement of said plunger.

26. The fluid metering actuator assembly according to claim 23, wherein said holder and said plunger include mating threaded surfaces that cooperate to provide said relative axial movement of said holder relative to said plunger.

27. The fluid metering actuator assembly according to claim 23, wherein said holder includes first and second mating members, said holder engaging at least a portion of said needle valve pin to couple said needle valve pin to said plunger while substantially preventing movement of said needle valve pin relative to said holder.

28. The fluid metering actuator assembly according to claim 27, wherein said portion of said needle valve pin comprises an enlarged end portion of said needle valve pin that is trapped by said first and second mating members of said holder to couple said needle valve pin to said plunger.

29. The fluid metering actuator assembly according to claim 17, wherein said actuator valve includes a valve seat and a valve component, and wherein one of said valve seat and said valve component is carried by said plunger.

30. The fluid metering actuator assembly according to claim 29, and including a seal member mounted on said valve seat, said seal member presenting an acute angle with respect to said valve component to reduce axial shift for the plunger assembly due to compression of said seal member when said actuator valve is in a closed condition.

31. The fluid metering actuator assembly according to claim 30, wherein said valve component is threadingly engaged with said plunger actuator, and wherein said seal member prevents back flow of liquid through mating thread on said plunger actuator and said valve component when said actuator valve is in a closed condition.

32. An adjustable fluid metering actuator assembly for a pressurized water closet, said fluid metering actuator assembly comprising:
a housing defining an inlet orifice;
a plunger assembly slidably contained within said housing, said plunger assembly including a plunger and a needle valve pin coupled to said plunger, said needle valve pin aligned with said inlet orifice, an axial position of said needle valve pin defining a fluid flow rate through said inlet orifice, wherein at least a portion of said needle valve pin that is located adjacent said inlet orifice varying in diameter, said needle valve pin axially repositionable with respect to said plunger to thereby adjust a bowl refill volume of said pressurized water closet.

33. The fluid metering actuator assembly according to claim 32, wherein said needle valve pin is axially repositionable to change diametral clearance between said portion of said needle valve pin and said inlet orifice to thereby adjust the fluid flow rate through said inlet orifice.

34. The fluid metering actuator assembly according to claim 32, wherein at least a portion of said needle valve pin is tapered.

35. The fluid metering actuator assembly according to claim 32, including a holder coupling said needle valve pin to said plunger.

36. The fluid metering actuator assembly according to claim 35, wherein said holder and said needle valve pin are repositionable with respect to said plunger along an axis the extends along the longitudinal axis of said plunger, and wherein said holder cooperates with said plunger to prevent said holder from slipping off said plunger during repositioning of said needle valve pin.

37. The fluid metering actuator assembly according to claim 35, wherein said plunger is rotatable relative to said housing and said holder is fixed against rotation relative to said housing, and wherein said holder and said plunger include mating threaded surfaces that cooperate to provide relative axial movement of said holder relative to said plunger in response to rotational movement of said plunger.

38. The fluid metering actuator assembly according to claim 35, wherein said holder includes first and second mating members, said holder engaging at least a portion of said needle valve pin to couple said needle valve pin to said plunger while substantially preventing movement of said needle valve pin relative to said holder.

39. The fluid metering actuator assembly according to claim 32, wherein said plunger assembly further includes a push rod slidably supported by said plunger and an adjustment member accessible from the exterior of said housing and operable to move said push rod axially to cause axial repositioning of said needle valve pin with respect to said plunger and said inlet orifice.

40. An adjustable fluid metering actuator assembly for controlling the operation of a flush valve of a pressurized water closet, said fluid metering actuator assembly comprising:
a housing having an inlet orifice;
a plunger assembly including a plunger actuator, a push rod carried by said plunger actuator, and a needle valve pin aligned with said inlet orifice;
an actuator valve for actuating said flush valve, said actuator valve including first and second valve components, said housing defining said first valve components and said second valve component carried by said plunger actuator and movable with said plunger to operate said actuator valve, said needle valve pin cooperating with said inlet orifice to establish a shut off time for said flush valve; and
a seal member carried by one of said valve components, said seal member having a surface that presents an acute angle with respect to a mating surface of the other one of said valve components, thereby reducing axial shift for the plunger assembly due to compression of the seal when the actuator valve is in the closed condition.

41. The fluid metering actuator assembly according to claim 40, wherein said other valve component is threadingly engaged with said plunger actuator, and wherein said seal member prevents back flow of liquid through mating thread on said plunger and said other valve component when the actuator valve is in a closed condition.
